(19) United States
(12) Patent Application Publication
(10) Pub. No.: US 2006/0273078 A1
(43) Pub. Date: Dec. 7, 2006

(54) PTC rod assembly and pre-heater including the same

(76) Inventor: Sung Mok Hong, Ahsan City (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/436,141

(22) Filed: May 17, 2006

(30) Foreign Application Priority Data
Mar. 20, 2005 (KR) 10-2005-0042386

(51) Int. Cl. B60L 1/02; H05B 3/02

(52) U.S. Cl. 219/202; 219/478

(57) ABSTRACT

A positive temperature coefficient (PTC) rod assembly having PTC elements including a channel-shaped, lower PTC rod, a contact plate with through-holes, and an insulator with protrusions penetrating through the through-holes. The insulator is coupled to and wraps a portion of the contact plate, and includes first and second seating sections exposing portions of side surfaces of the contact plate. PTC elements are in the first seating sections and in contact with the contact plate, heat transfer blocks are in the second seating sections in contact with the contact plate, and an upper PTC rod is coupled to the lower PTC rod to cover an open portion of the lower PTC rod. A vehicle pre-heater includes a plurality of such PTC rod assemblies in parallel to one another, with heat radiation fin assemblies coupled in close contact with both surfaces of each of the PTC rod assemblies, a pair of frames coupled to outer side surfaces of the outermost heat radiation fin assemblies, and first and second housings coupled to both longitudinal ends of a combination of the PTC rod assemblies, the heat radiation fin assemblies and the frames. Housing terminals are provided in the housings and serve as cathode terminals.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to a positive temperature coefficient (hereinafter, referred to as “PTC”) rod assembly and a pre-heater for a vehicle including the same, and more particularly, to a PTC rod assembly in which a coupling force between a contact plate and an insulator is enhanced and a coupling position between a PTC element and a heat transfer block can be clearly defined, and a pre-heater for a vehicle constructed such that heat generated from PTC elements is uniformly transferred only to a heat radiation fin assembly.

### BACKGROUND OF THE INVENTION AND TECHNICAL PROBLEMS POSED BY THE PRIOR ART

A general vehicle has a heating apparatus for heating the interior of the vehicle or removing moisture or frost on a windshield of the vehicle using thermal energy of cooling water heated by heat generated from an engine of the vehicle.

In the heating apparatus, since the cooling water, which flows around the engine after the engine is started, is introduced into a heater, it takes a great deal of time to heat the cooling water and to subsequently heat the interior of the vehicle. Accordingly, there is a problem in that a driver and/or passenger(s) may be forced to stay in the cold interior of the vehicle for a certain period of time after the engine is started.

To address this problem, Korean Laid-Open Patent Publication No. 10-2004-0089570 discloses an apparatus for accommodating ceramic heating elements such as PTC elements.

One known apparatus for accommodating the PTC elements is shown in FIGS. 1 and 2, where FIG. 1 is a perspective view of a contact plate and an insulator employed in this known apparatus, with FIG. 2 being a sectional view of the apparatus. This apparatus includes an insulator 20 made of an electrically insulative material, and a contact plate 22 embedded in and coupled to the insulator 20. The insulator 20 includes recesses 24 in which the PTC elements 26 are seated to come into contact with the contact plate 22, and supports 28 formed longitudinally at both side ends thereof. A longitudinal groove 30 is formed in an inner surface of each of the supports 28, and a portion of the contact plate 22 on the side of a terminal lug 32 thereof is completely surrounded by an insulator sheath 34. The supports 28 are connected to each other by traverse ribs 38 spaced apart from one another by a certain distance in the longitudinal direction and disposed in parallel to one another. A plurality of studs 38 are provided on inner side surfaces of the supports 28 and the traverse ribs 36. When the PTC elements 26 are seated in the recesses 24, the studs 38 are pressed against side surfaces of the PTC elements to fix the PTC elements 26. Hooks 40 protruding in lateral opposite directions are formed at a side of the insulator 20 opposite to the insulator sheath 34 so that the insulator 20 can be fixed to a heating device, and the insulator is introduced into a profile tube 42.

To prevent the contact plate 22 from coming into contact with the profile tube 42, an insulative strip 44 is coupled to a side surface of the contact plate opposite to a side surface with which the PTC elements 26 are in contact.

In an apparatus for accommodating the PTC elements constructed as above, since the insulator 20 and the contact plate 22 are coupled to each other by a friction force therebetween, there is a risk of release of the coupling of the insulator 20 with the contact plate 22. Further, there is a disadvantage in that a failure may occur due to introduction of dust or other foreign substances into a space between the insulator 20 and the profile tube 42. Moreover, since the PTC elements 26 are coupled to only one side of the contact plate 22 in this known apparatus, the heat may not be transferred uniformly as desired.

The present invention is directed toward overcoming one or more of the problems set forth above.

### SUMMARY OF THE INVENTION

In one aspect of the present invention, a positive temperature coefficient (PTC) rod assembly of a pre-heater for a vehicle is provided, where the PTC rod assembly includes PTC elements including a channel-shaped, lower PTC rod, a contact plate with two or more through-holes at predetermined intervals, and an insulator having protrusions adapted to penetrate through the through-holes. The insulator is coupled to the contact plate, wraps a portion of the contact plate, and includes one or more first and second seating sections exposing portions of side surfaces of the contact plate. PTC elements are in the first seating sections and in contact with the contact plate, heat transfer blocks are in the second seating sections in contact with the contact plate, and an upper PTC rod is coupled to the lower PTC rod to cover an open portion of the lower PTC rod.

In one form of this aspect of the present invention, the insulator includes supports coupled to one ends of the protrusions and placed on an outer surface of the contact plate, and the contact plate and the insulator are formed integrally with each other through a dual-injection molding process. In a further form, the supports are formed in pairs to face each other at positions on the insulator corresponding to lateral side ends of the contact plate.

In another form of this aspect of the present invention, the insulator includes a first insulator formed with the protrusions and coupled to one side surface of the contact plate; and a second insulator formed with coupling holes to be engaged with the protrusions that have passed the through-holes, where the second insulator is coupled to the other side surface of the contact plate.

In still another form of this aspect of the present invention, the insulator has guides formed at both ends thereof to hermetically seal both ends of each of the PTC rods. In a further form, each of the guides has the same cross-sectional shape as the PTC rods and is coupled to the PTC rods whereby an inner side surface of the guide is brought into close contact with outer side surfaces of ends of the PTC rods. In another further form, the contact plate has a terminal formed at one end thereof, with the terminal protruding outside of the corresponding guide and being bent into a step shape and, in a still further form, the terminal at the end is folded in lateral sides of the end of the contact plate.

In yet another form of this aspect of the present invention, the insulator has guides formed at both ends thereof, with each of the guides having a protrusion formed thereon. The contact plate has auxiliary guides formed at portions corresponding to the guides of the insulator and through-holes formed at portions corresponding to the protrusions of the guides of the insulator, and the guides and the auxiliary guides are formed to hermetically seal both ends of each of the PTC rods.

In another form of this aspect of the present invention, the first seating sections have a width larger than that of the second seating sections. In a further form, the first seating sections have a width equal to that of the contact plate.

In still another form of this aspect of the present invention, the first seating sections and the second seating sections have a width equal to that of the contact plate.

In yet another form of this aspect of the present invention, each of the first seating sections and the second seating sections has at least one spacing protrusion formed on a side wall thereof.

In another aspect of the present invention, a pre-heater for a vehicle is provided, including a plurality of PTC rod assemblies according to the first aspect of the present invention with the PTC rod assemblies being arranged in parallel to one another. One or more heat radiation fin assemblies are coupled to be in close contact with both surfaces of each of the PTC rod assemblies. A pair of frames is coupled to outer side surfaces of the outermost heat radiation fin assemblies, and a first housing and a second housing are coupled to both longitudinal ends of a combination of the PTC rod assemblies, the heat radiation fin assemblies and the frames. Housing terminals are provided in the housings and serve as cathode terminals.

In one form of this aspect of the present invention, each of the outermost PTC rod assemblies has PTC elements mounted on a surface thereof facing the interior of the pre-heater.

In another form of this aspect of the present invention, at least one of the PTC rod assemblies has the PTC elements and the heat transfer blocks alternately mounted on both side surfaces thereof.

In still another form of this aspect of the present invention, the number of the heat radiation fin assemblies coupled to a side of each of the PTC rod assemblies where the PTC elements are mounted is larger than that of the heat radiation fin assemblies coupled to the other side of the PTC rod assembly where a PTC element is not mounted.

In yet another form of this aspect of the present invention, each of the frames has an elongated, reinforcing groove formed on a surface thereof brought into contact with the heat radiation fin assembly in a longitudinal direction of the contact surface with the heat radiation fin assembly.

In another form of this aspect of the present invention, an intermediate portion of a surface of the frame in contact with the heat radiation fin assembly slantly protrudes toward the corresponding heat radiation fin assembly.

In still another form of this aspect of the present invention, each of the housing terminals is provided with a bent plate to be brought into contact with one end of the PTC rod.

### BRIEF DESCRIPTION OF THE DRAWINGS

FIG. 1 is a perspective view of a contact plate and an insulator employed in a known prior art apparatus for accommodating PTC elements;

FIG. 2 is a sectional view of the FIG. 1 apparatus;

FIG. 3 is an exploded perspective view of a PTC rod assembly according to the present invention;

FIGS. 4 to 6 are perspective views sequentially showing processes of manufacturing a terminal of a contact plate included in the PTC rod assembly according to the present invention;

FIG. 7 is a side view of the contact plate and an insulator included in the PTC rod assembly according to the present invention;

FIG. 8 is a sectional view of the contact plate and the insulator taken along line 8-8 in FIG. 7;

FIG. 9 is a sectional view the contact plate and the insulator taken along line 9-9 in FIG. 7;

FIG. 10 is an exploded sectional view of the insulator constructed to be detachably coupled to the contact plate;

FIG. 11 is a perspective view of the insulator of the PTC rod assembly according to the present invention, showing a pair of supports provided in the insulator;

FIG. 12 is a perspective view of the insulator of the PTC rod assembly according to the present invention, showing guides provided respectively in the insulator and the contact plate;

FIG. 13 is an exploded perspective view of a pre-heater for a vehicle according to the present invention;

FIGS. 14 to 16 are exploded views showing coupling positions of PTC elements and heat transfer blocks in respective PTC rod assemblies included in the pre-heater for a vehicle according to the present invention;

FIG. 17 is a view showing a coupled state of a first housing and the PTC rod assemblies included in the pre-heater for a vehicle according to the present invention;

FIG. 18 is a sectional perspective view of the housing employed in the pre-heater according to the present invention; and

FIG. 19 is a sectional view of the housing, showing a coupling structure of one of housing terminals.

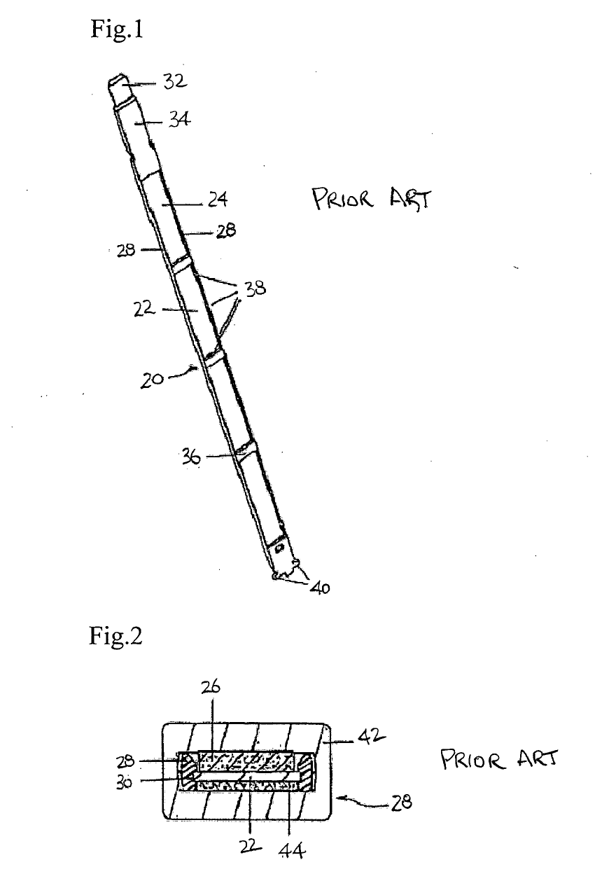

### DETAILED DESCRIPTION OF THE INVENTION

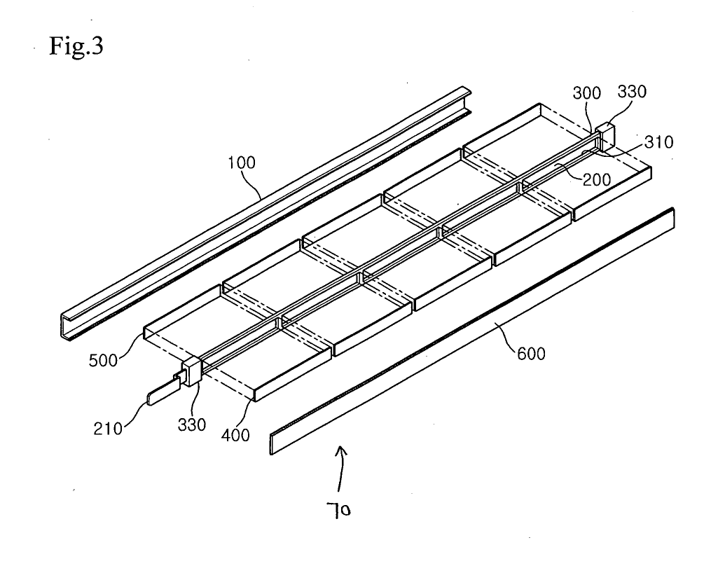

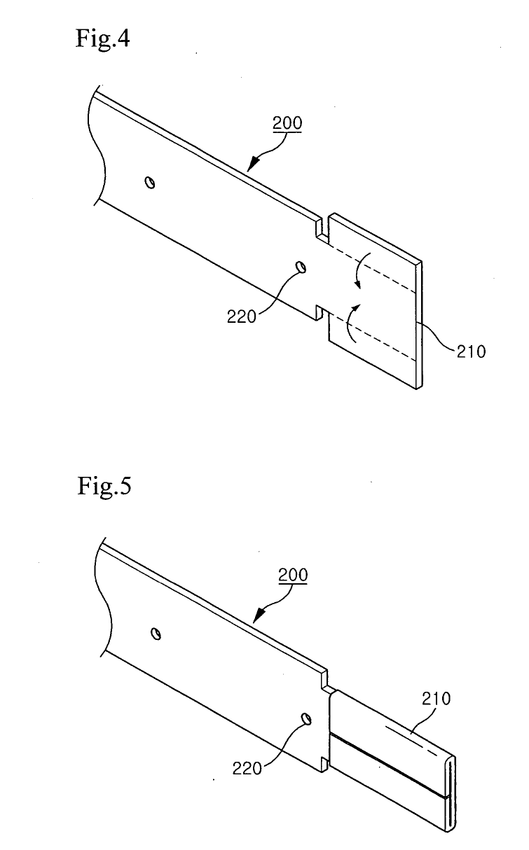

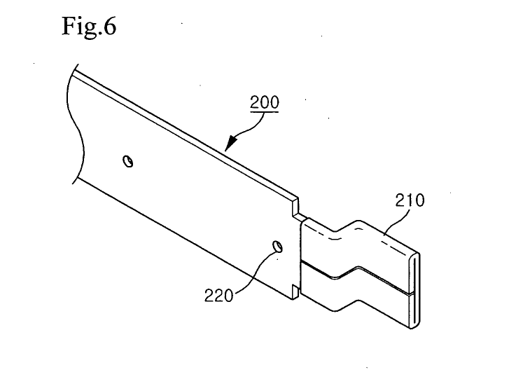

FIG. 3 is an exploded perspective view of a PTC rod assembly according to the present invention, and FIGS. 4 to 6 are perspective views sequentially showing processes of manufacturing a terminal of a contact plate included in the PTC rod assembly according to the present invention;

As shown in FIGS. 3 to 6, the PTC rod assembly 70 according to the present invention includes a lower PTC rod 100, a contact plate 200, an insulator 300, PTC elements 400, heat transfer blocks 500, and an upper PTC rod 600.

The lower PTC rod 100 is constructed in the form of a channel. The contact plate 200 has a terminal 210 formed by bending one end portion thereof into a step shape, and two or more through-holes 220 formed at predetermined intervals. The contact plate 200 is placed within the lower PTC rod 100.

The insulator 300 is formed to wrap a portion of the contact plate 200 and has a plurality of first seating sections 310 formed to expose a portion of one side surface of the contact plate 200 and a plurality of second seating sections (not shown) formed to expose a portion of the other side surface of the contact plate 200.

The PTC elements 400 are coupled into the first seating sections 310 in a press-fit manner so as to be in contact with the contact plate 200, and the heat transfer blocks 500 are coupled into the second seating sections in a press-fit manner so as to be in contact with the contact plate 200.

The upper PTC rod 600 is coupled to the lower PTC rod 100 so as to cover an open portion of the lower PTC rod.

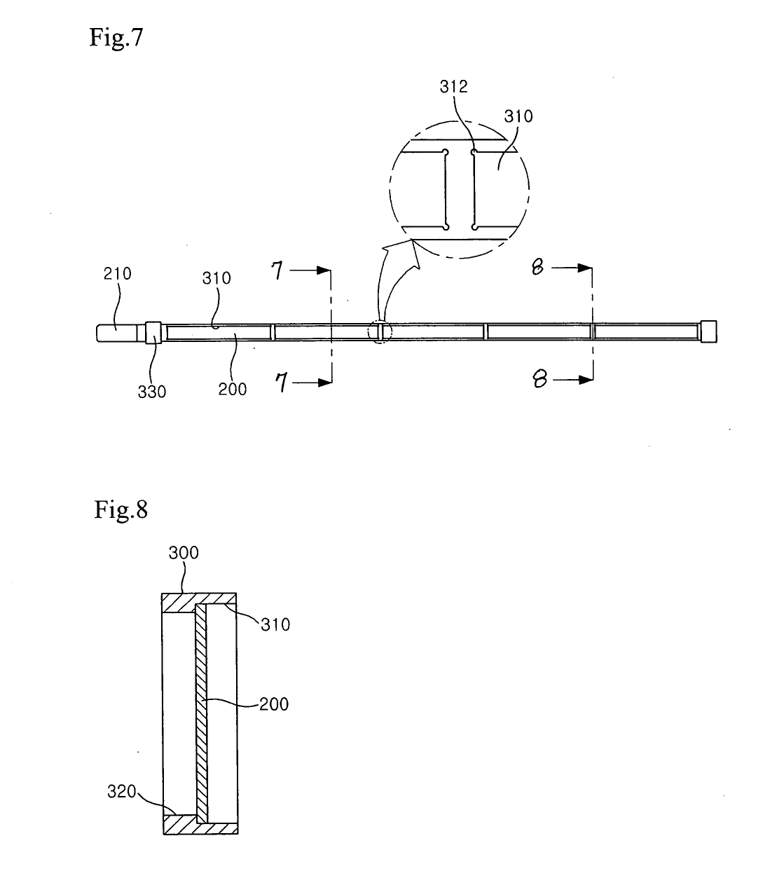

The insulator 300 serves to prevent the contact plate 200 from coming into contact with the PTC rods 100 and 600, and has supports 340 that are formed to be placed on an outer surface of the contact plate 200. Further, the insulator 300 is coupled to the contact plate 200 so as to wrap a portion of the outer surface of the contact plate 200. A coupling structure between the contact plate 200 and the insulator 300 will be described below with reference to the accompanying drawings (FIGS. 7 to 10).

Guides 330 are formed at both ends of the insulator 300 such that inner surfaces of the guides come into close contact with outer surfaces of both ends of each of the PTC rods 100 and 600 to hermetically seal the both ends of each of the PTC rods 100 and 600. At this time, the guides 330 are formed to have the same cross-sectional shape as the PTC rods 100 and 600. Accordingly, since inner spaces of the upper and lower PTC rods 600 and 100 are hermetically sealed by the guides 330, there is no case where a fire breaks out due to contact of dust or other foreign substances with the PTC elements 400.

The contact plate 200 has the terminal 210 formed at one end thereof to protrude outside of the guides 330. The terminal 210 may be formed by bending the end of the contact plate into a step shape. The width of the end of the contact plate 200 where the terminal 210 is to be formed is larger than that of an intermediate portion of the contact plate 200, and each of lateral sides of the end of the contact plate 200 is folded in half (see FIGS. 4-5). The thickness of the terminal 210 formed in this manner is thus twice as large as that of the intermediate portion of the contact plate 200, resulting in increased strength. Accordingly, there is an advantage in that the terminal can be more stably connected to a connector or housing for application of an electric current.

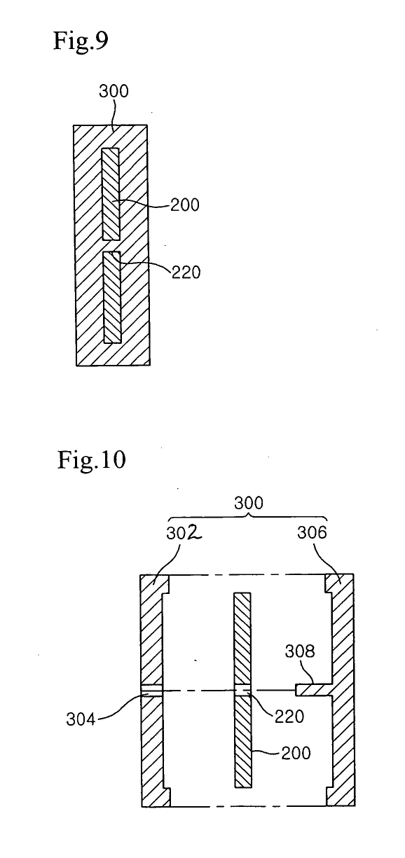

The previously referenced coupling structure between the contact plate 200 and the insulator 300 will now described. FIG. 7 is a side view of the contact plate 200 and the insulator 300 included in the PTC rod assembly according to the present invention, FIG. 8 is a sectional view of the contact plate 200 and the insulator 300 taken along line 8-8 in FIG. 7, and FIG. 9 is a sectional view the contact plate 200 and the insulator 300 taken along line 9-9 in FIG. 7.

As shown in FIGS. 7 to 9, the insulator 300 employed in the present invention may be coupled to the contact plate 200 through injection molding and includes supports (see FIG. 9) penetrating through the though-holes 220 formed in the contact plate 200 so as to wrap a portion of the outer surface of the contact plate 200. Accordingly, so far as the supports penetrating through the though-holes 220 are not broken, the coupling state between the insulator 300 and the contact plate 200 is maintained. Thus, as compared with a conventional insulator that is coupled to a contact plate by only a friction force between the insulator and an outer surface of the contact plate, the coupling force between the insulator 300 and the contact plate 200 in the disclosed structure is remarkably enhanced. The insulator 300 may be manufactured through an injection molding process performed separately from a process of manufacturing the contact plate 200, or may be manufactured integrally with the contact plate 200 through a dual-injection molding process.

Moreover, to prevent the coupling positions of the PTC elements 400 and the heat transfer blocks 500 from being interchanged, the first and second seating sections 310, 320 may be formed to have different widths (see FIG. 8). In this embodiment, although the first seating sections 310 are formed to have a width larger than that of the second seating sections 320 as in the FIG. 8 embodiment, the second seating sections 320 may be formed to have a width larger than that of the first seating sections 310 according to a user's selection. In order to ensure that an entire side surface of each of the PTC elements 400 comes into contact with the contact plate 200, each of the first seating sections 310 is formed to have a width which is effectively identical to that of the contact plate 200. Furthermore, the second seating sections 320 may be formed to have a width identical to that of the contact plate 200.

If the first seating sections 310 are formed in a simple rectangular shape upon manufacture of the insulator 300 through injection molding, there are frequent cases where corners of each of the first seating sections 310 are not formed at a right angle due to characteristics of the injection molding. If the corners of each of the first seating sections 310 are not formed at a right angle as such, the PTC elements 400 cannot be brought into close contact with the contact plate 200, resulting in deteriorated heat transfer function. To solve this problem, the first seating sections 310 employed in the present invention are formed in a rectangular shape and additionally have notches 312 formed at respective corners of the first seating sections 319 (see FIG. 7). Once the notches 312 are formed as described above, the PTC elements 400 can be completely brought into close contact with the contact plate 200 even if there is a slight dimensional error at the corners of the first seating sections 310. Similar notches may also be formed at respective corners of the second seating sections 320 to improve close contact of the heat transfer blocks 500 with the contact plate 200.

FIG. 10 is an exploded sectional view of an insulator 300 constructed to be detachably coupled to the contact plate 200 while wrapping the contact plate. This insulator 300 may include a first insulator 306 coupled to one side surface of the contact plate 200 by means of protrusions 308 that are formed on one side surface of the first insulator to penetrate through the through-holes 220, and a second insulator 302 that has coupling holes 304 engaged with the protrusions 308 penetrating through the through-holes 220 and is coupled to the other side surface of the contact plate 200. Since a coupling state between the insulator and the contact plate 200 can be released without damaging the insulator, the insulator 300 constructed in this manner has an advantage in that maintenance thereof can be easily performed.

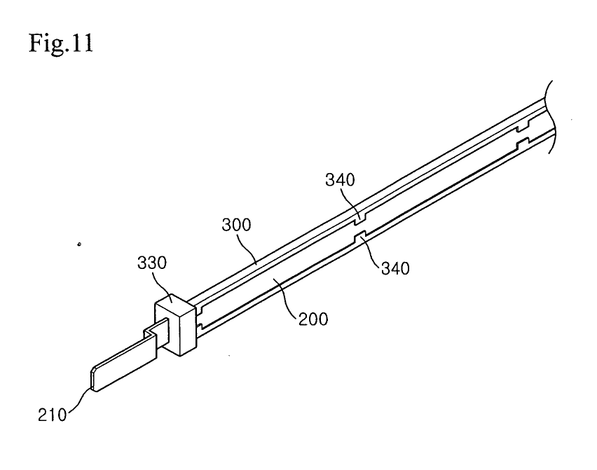

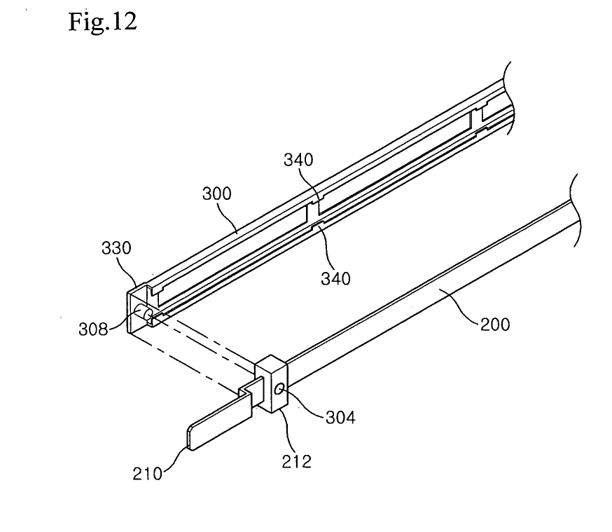

FIG. 11 is a perspective view of the insulator of another PTC rod assembly according to the present invention, showing a pair of supports provided in the insulator, and FIG. 12 is a perspective view of the insulator of still another PTC rod assembly according to the present invention, showing guides provided respectively in the insulator and the contact plate.

Specifically, as shown in FIG. 11, the supports 340 may be formed in pairs to face each other at certain positions on the insulator corresponding to lateral side ends of the contact plate 200. As described above, once the supports 340 are formed in pairs to face each other, the PTC elements 400 are coupled such that respective corners thereof are in close contact with side walls of the supports 340, with the through-holes 220 of the contact plate 220 provided at regions where the supports 340 are formed.

As shown in FIG. 12, each of the guides 330 provided on the insulator 300 is formed to take the shape of a flat plate and has a protrusion 308 protruding toward the contact plate 200. An auxiliary guide 212 is provided in a portion of the contact plate 220 corresponding to each of the guides 330. Through-holes 304 that are to be engaged with the protrusion 308 are formed in portions of the contact plate 200 and the auxiliary guide 212 corresponding to the protrusion 308. When the protrusions 308 are inserted into and engaged with the through-holes 304, the guides 330 and the auxiliary guides 212 are coupled to each other. Moreover, the guides 330 and the auxiliary guides 212 may be advantageously formed to hermetically seal both ends of each of the PTC rods when these guides are coupled to each other.

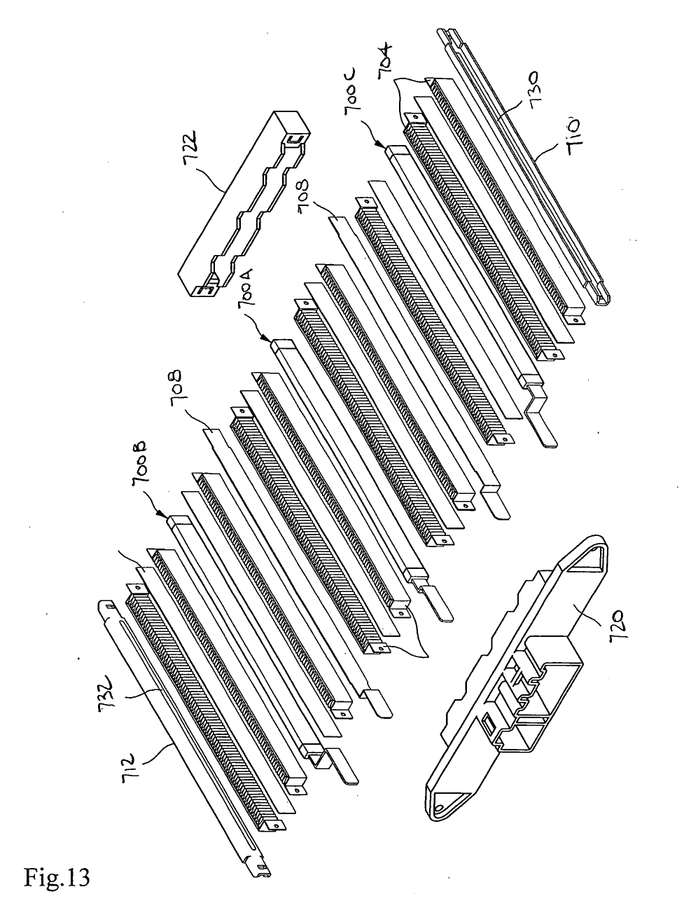

As shown in FIG. 13, the pre-heater for a vehicle according to the present invention comprises a plurality of PTC rod assemblies 700A to 700C disposed in parallel to one another in a longitudinal direction; heat radiation fin assemblies 704 brought into contact with and coupled to both sides of each of the PTC rod assemblies 700A to 700C; cathode terminals 708 each of which is placed between adjacent heat radiation fin assemblies 704; a pair of frames 710 and 712 coupled to outer side surfaces of the outermost heat radiation fin assemblies 704, respectively; and a first housing 720 and a second housing 722 coupled respectively to both longitudinal ends of a combination of the PTC rod assemblies 700A to 700C, the heat radiation fin assemblies 704, the cathode terminals 708 and the frames 710 and 712. Heat generated from the PTC elements installed within the PTC rod assemblies 700A to 700C is transferred to the heat radiation fin assemblies 704 so as to heat air that passes through the heat radiation fin assemblies 704.

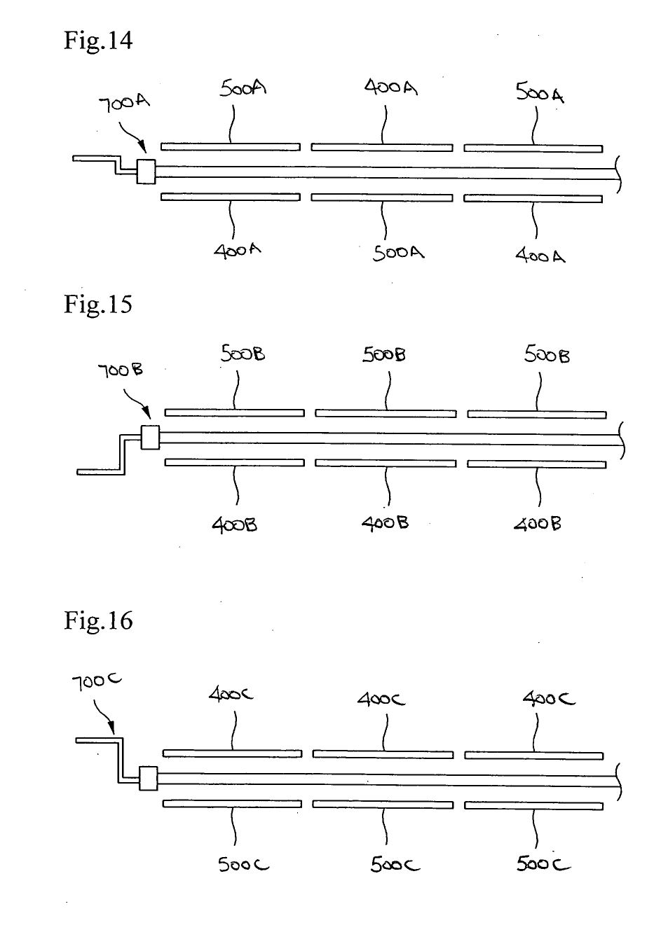

If the pre-heater for a vehicle is constructed such that heat generated from the PTC elements is not transferred to the outside but is transferred to only the heat radiation fin assemblies 704 disposed inside, the efficiency of the pre-heater can be improved. Accordingly, as shown in FIG. 14, PTC elements 400A and heat transfer blocks 500A are mounted alternately on both surfaces of the PTC rod assembly 700A located at a middle position so that heat can be uniformly transferred in both lateral directions. In addition, as shown in FIGS. 15 and 16, PTC elements 400B and 400C are mounted on surfaces of the PTC rod assemblies 700B and 700C, which face the interior of the pre-heater, and heat transfer blocks 500B and 500C are mounted on surfaces of the PTC rod assemblies 700B and 700C, which face the exterior of the pre-heater.

However, the coupling positions of the PTC elements 400 and the heat transfer blocks 500 are not limited thereto but may be changed optionally according to the user's selection.

In order to prevent heat from being radiated to the outside through the housings 720 and 722, it is preferred that the PTC elements 400A to 400C be spaced apart by certain distances from the housings 720 and 722.

Since heat transferred to the heat radiation fin assemblies 704 desirably is not to be transferred to the frames 710 and 712, the frames 710 and 712 are provided with elongated, reinforcing grooves 730 and 732 that are longitudinally formed in surfaces of the frames brought into contact with the heat radiation fin assemblies 704 to reduce a contact area between each of the frames and the corresponding heat radiation fin assembly. When the reinforcing grooves 730 and 732 are formed as such, a contact area between each of the frames 710 and 712 and the corresponding heat radiation fin assembly 704 is reduced, resulting in a lowered heat transfer rate. Moreover, since the interiors of the reinforcing grooves 730 and 732 are filled with air, heat in the heat radiation fin assemblies 704 is transferred to the frames 710 and 712 through the air and, since air has a very low heat transfer rate, the amount of heat transferred through air can be regarded as a negligible quantity.

The PTC rod assemblies 700A to 700C and the heat radiation fin assemblies 704 heated by heat generated from the PTC elements are increased in volume and then push outwardly on the frames 710 and 712 coupled to both lateral outer sides of the combination thereof. As a result, the frames 710 and 712 of which the longitudinal ends are coupled to the housings 720 and 722 may be bulged outward at intermediate portions thereof. If the frames 710 and 712 are bulged, there is a problem in that the coupling state of respective components disposed between the frames 710 and 712 may be strained. Accordingly, the frames 710 and 712 employed in the present invention are advantageously formed such that intermediate portions of the surfaces thereof brought into contact with the heat radiation fin assemblies 704 protrude at a slant toward the corresponding heat radiation fin assemblies 704. As compared with a conventional straight frame, the frames 710 and 712 of which the intermediate portions protrude inward at a slant are much less bulged even though they are subjected to pressure resulting from expansion of the PTC rod assemblies 700A to 700C and the heat radiation fin assemblies 704. Further, since the reinforcing grooves 730 and 732 serve as reinforcing ribs for preventing the bulging in the frames 710 and 712 employed in the present invention, there is an advantage in that the frames hardly undergo deformation in shape due to an external force.

Although the additional cathode terminals 708 are provided between the heat radiation fin assemblies 704 in this embodiment, the frames 710 and 712 of the pre-heater for a vehicle according to the present invention may be constructed to perform the function of a cathode terminal. When the frames 710 and 712 serve as cathode terminals, there are advantages in that the inner structure of the pre-heater for a vehicle is simplified and production costs can be reduced.

As described above, the heat radiation fin assemblies 704 are coupled to both side surfaces of each of the PTC rod assemblies 700A to 700C. Since the amount of heat generated from one side of the PTC rod assembly where the PTC elements are mounted is higher than the amount of heat generated from the other side of the PTC rod assembly where the heat transfer blocks are mounted, a plurality of heat radiation fin assemblies 704 are stacked laterally at the side of the PTC rod assembly where the PTC elements are mounted, and heat radiation fin assemblies 704 of which the number is smaller than the number of the heat assemblies coupled to the side of the PTC rod assembly where the PTC elements are mounted are coupled to the other side of the PTC rod assembly where a PTC element is not mounted. In this embodiment, two heat radiation fin assemblies 704 are coupled to one side of the PTC rod assembly where the PTC elements are mounted and one heat radiation fin assembly 704 is coupled to the other side of the PTC rod assembly where the heat transfer blocks are mounted. However, the number of heat radiation fin assemblies to be coupled to a side of each of the PTC rod assemblies 700A to 700C is not limited thereto but may be changed variously according to user's selection.

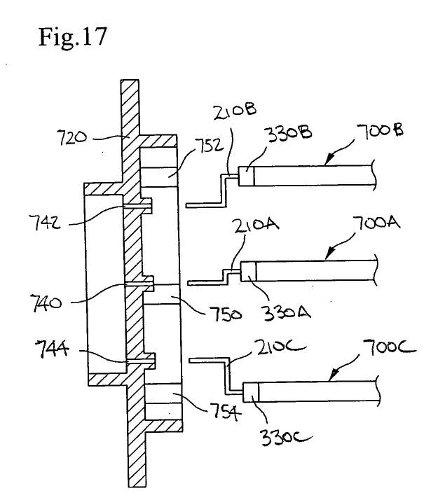

FIG. 17 is a view showing a coupled state of the first housing and the PTC rod assemblies included in the pre-heater for a vehicle according to the present invention. The respective PTC rod assemblies 700A to 700C of the pre-heater for a vehicle according to the present invention have different locations of the PTC elements and the heat transfer blocks therein. Thus, if the PTC rod assemblies 700A to 700C are coupled to the first housing 720 at different positions, there are several problems in that the efficiency of the pre-heater is lowered or the pre-heater is out of order. In order to avoid these problems, the PTC rod assemblies 700A to 700C are formed such that the lengths of bent portions of the terminals 210A to 210C thereof differ from one another. Accordingly, in the first housing 720, the distance between each of coupling terminals 740, 742, 744 to which the terminals 210A to 210C are to be coupled and each of seating recesses 750, 752, 754 for receiving guides 330A to 330C is determined to conform to the length of the bent portion of each of the terminals 210A to 210C. Accordingly, each of the PTC rod assemblies 700A to 700C can be coupled at only a designated position, thereby avoiding confusion when assembling the PTC rod assemblies 700A to 700C. Each of the PTC rod assemblies 700A to 700C is coupled in such a manner that each of the guides 330A to 330C is completely inserted into the housing 720.

Since the pre-heater for a vehicle comprising the PTC rod assembly according to the present invention is identical to a conventional pre-heater in view of their basic operations except that respective components thereof are different from each other in structure, a detailed description of the basic operation thereof is not necessary her for those skilled in the art.

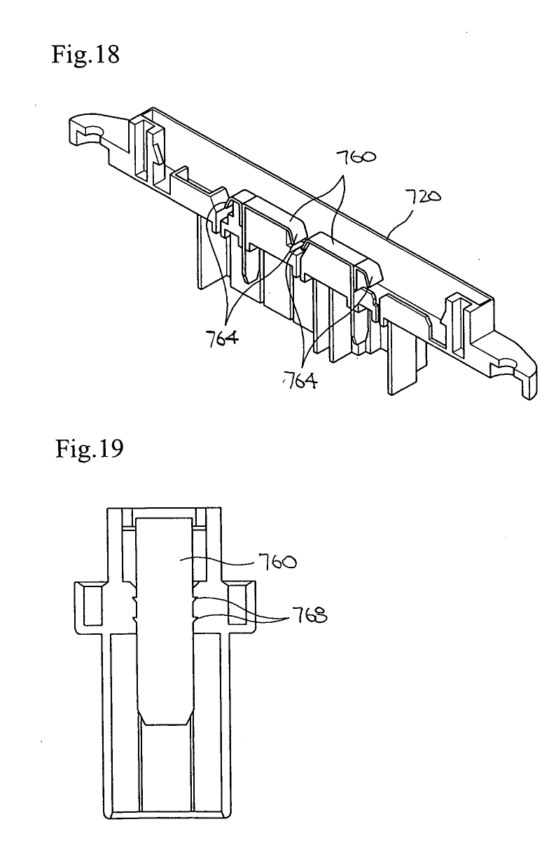

As shown in FIGS. 18 and 19, the first housing 720 employed in the present invention comprises housing terminals 760 each of which one end is embedded in the first housing 720 and which has bent plates 764 to be brought into contact with one end of the upper PTC rod 600 or the lower PTC rod 100 introduced into the first housing 720. When the housing terminals 760 to be brought into contact with the PTC rods 100 and 600 are provided as such, the entire PTC rods 100 and 600 serve as cathode terminals. Thus, it is advantageously not necessary to provide an additional cathode terminal.

A portion of each of the housing terminals 760, which is embedded in the first housing 720, is formed with locking protrusions 768 (see FIG. 19) to be caught in the first housing so that the housing terminal 760 cannot come out from the housing 720. Further, each of the locking protrusions 768 may be advantageously formed to have a pointed tip and to be inclined in a direction in which the housing terminal 760 is withdrawn.

The PTC rod assembly 70 according to the present invention has advantages in that a coupling force between the contact plate 200 and the insulator 300 is enhanced, foreign substances are not introduced into the PTC rod assembly 70, and the strength of a terminal is increased. Further, the pre-heater for a vehicle according to the present invention is advantageous in that heat generated from the PTC elements is not transferred to the outside but is uniformly transferred to the interior of the pre-heater, coupling forces of the respective components placed between the frames are increased, and close contact between the PTC rod assembly 70 and the heat radiation fin assembly are improved.

Although the present invention has been described in connection with the preferred embodiments, the scope of the present invention is not limited by the specific embodiments but should be construed by the appended claims. Further, it should be understood by those skilled in the art that various changes and modifications can be made thereto without departing from the scope of the present invention. Moreover, still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A positive temperature coefficient (PTC) rod assembly of a pre-heater for a vehicle, the PTC rod assembly including PTC elements, comprising:
a channel-shaped, lower PTC rod;
a contact plate with two or more through-holes at predetermined intervals;
an insulator having protrusions adapted to penetrate through the through-holes, the insulator being coupled to the contact plate and wrapping a portion of the contact plate and including one or more first and second seating sections exposing portions of side surfaces of the contact plate;
PTC elements in the first seating sections and in contact with the contact plate;
heat transfer blocks in the second seating sections in contact with the contact plate; and
an upper PTC rod coupled to the lower PTC rod to cover an open portion of the lower PTC rod.

2. The PTC rod assembly as recited in claim 1, wherein the insulator comprises supports coupled to one ends of the protrusions and placed on an outer surface of the contact plate, and the contact plate and the insulator are formed integrally with each other through a dual-injection molding process.

3. The PTC rod assembly as recited in claim 1, wherein the insulator comprises a first insulator formed with the protrusions and coupled to one side surface of the contact plate; and a second insulator formed with coupling holes to be engaged with the protrusions that have passed the through-holes, the second insulator being coupled to the other side surface of the contact plate.

4. The PTC rod assembly as recited in claim 1, wherein the insulator has guides formed at both ends thereof to hermetically seal both ends of each of the PTC rods.

5. The PTC rod assembly as recited in claim 4, wherein each of the guides has the same cross-sectional shape as the PTC rods and is coupled to the PTC rods whereby an inner side surface of the guide is brought into close contact with outer side surfaces of ends of the PTC rods.

6. The PTC rod assembly as recited in claim 1, wherein the insulator has guides formed at both ends thereof, each of the guides having a protrusion formed thereon; the contact plate has auxiliary guides formed at portions corresponding to the guides of the insulator and through-holes formed at portions corresponding to the protrusions of the guides of the insulator; and the guides and the auxiliary guides are formed to hermetically seal both ends of each of the PTC rods.

7. The PTC rod assembly as recited in claim 1, wherein the first seating sections have a width larger than that of the second seating sections.

8. The PTC rod assembly as recited in claim 7, wherein the first seating sections have a width equal to that of the contact plate.

9. The PTC rod assembly as recited in claim 1, wherein the first seating sections and the second seating sections have a width equal to that of the contact plate.

10. The PTC rod assembly as recited in claim 2, wherein the supports are formed in pairs to face each other at positions on the insulator corresponding to lateral side ends of the contact plate.

11. The PTC rod assembly as recited in claim 4, wherein the contact plate has a terminal formed at one end thereof, the terminal protruding outside of the corresponding guide and being bent into a step shape.

12. The PTC rod assembly as recited in claim 11, wherein the terminal at the end comprises folded in lateral sides of the end of the contact plate.

13. The PTC rod assembly as recited in claim 1, wherein each of the first seating sections and the second seating sections has at least one spacing protrusion formed on a side wall thereof.

14. A pre-heater for a vehicle, comprising:
a plurality of PTC rod assemblies according to claim 1, the PTC rod assemblies being arranged in parallel to one another;
one or more heat radiation fin assemblies coupled to be in close contact with both surfaces of each of the PTC rod assemblies;
a pair of frames coupled to outer side surfaces of the outermost heat radiation fin assemblies;
a first housing and a second housing coupled to both longitudinal ends of a combination of the PTC rod assemblies, the heat radiation fin assemblies and the frames; and
housing terminals provided in the housings and serving as cathode terminals.

15. The pre-heater as recited in claim 14, wherein each of the outermost PTC rod assemblies has PTC elements mounted on a surface thereof facing the interior of the pre-heater.

16. The pre-heater as recited in claim 14, wherein at least one of the PTC rod assemblies has the PTC elements and the heat transfer blocks alternately mounted on both side surfaces thereof.

17. The pre-heater as recited in claim 14, wherein the number of the heat radiation fin assemblies coupled to a side of each of the PTC rod assemblies where the PTC elements are mounted is larger than that of the heat radiation fin assemblies coupled to the other side of the PTC rod assembly where a PTC element is not mounted.

18. The pre-heater as recited in claim 14, wherein each of the frames has an elongated, reinforcing groove formed on a surface thereof brought into contact with the heat radiation fin assembly in a longitudinal direction of the contact surface with the heat radiation fin assembly.

19. The pre-heater as recited in claim 14, wherein an intermediate portion of a surface of the frame in contact with the heat radiation fin assembly slantly protrudes toward the corresponding heat radiation fin assembly.

20. The pre-heater as recited in claim 14, wherein each of the housing terminals is provided with a bent plate to be brought into contact with one end of the PTC rod.
